(19) United States
(12) Patent Application Publication
(10) Pub. No.: US 2009/0135140 A1
(43) Pub. Date: May 28, 2009

(54) SYSTEM AND METHOD FOR ACCURATE LIFT-DETECTION OF AN INPUT DEVICE

(75) Inventors: Christophe Constantin, Cossonay (CH); Marc Bidiville, Monaco (MC); Olivier Theytaz, Savigny (CH); Olivier Mathis, Grimisuat (CH); Boris Karamata, Rivaz (CH); Nicolas Chauvin, Chexbres (CH); Jacques Robert, Le Mont-sur-Lausanne (CH)

Correspondence Address: THE LAW OFFICE OF DEEPTI PANCHAWAGH - JAIN, C/O CPA GLOBAL, PO BOX 52050, MINNEAPOLIS, MN, 55402, US

(73) Assignee: LOGITECH EUROPE S.A., Romanel-sur-Morges (CH)

(21) Appl. No.: 12/051,975

(22) Filed: Mar. 20, 2008

Related U.S. Application Data
(60) Provisional application No. 60/990,493, filed on Nov. 27, 2007.

(51) Int. Cl. G06F 3/02

(52) U.S. Cl. 345/166

(57) ABSTRACT

Various systems and methods are employed for lift-detection. Beam triangulation can be used, and in one embodiment, an optical lift detection module is separate from the optical tracking module. In one embodiment, a capacitive lift detection technique is used. A capacitor is built into the bottom case of the mouse. When the mouse is resting on a surface, the surface material serves as a dielectric for the capacitor, while air serves as the dielectric when the mouse is lifted. This dielectric change leads to a change in the capacitance value, leading to detection of lift. In one embodiment, a capacitor with an easily compressable material inserted between the two electrodes is used. In another embodiment, a mechanical plunger with an elastic membrane is used for lift detection. Lift detection can be tunable and/or customizable. The actual height of the life can be detected, rather than simple on-off notifications.

### CROSS-REFERENCES TO RELATED APPLICATIONS

This application claims the benefit of, and priority to, U.S. Provisional Application No. 60/990,493, entitled “System and Method for Accurate Lift-Detection of an Input Device”, filed on Nov. 27, 2007, which is hereby incorporated by reference herein in its entirety.

### BACKGROUND OF THE INVENTION

1. Field of the Invention

The present invention relates generally to input devices, and more particularly, to lift detection in input devices.

2. Description of the Related Arts

Input devices, such as a mouse or a trackball, are well known peripheral devices in data processing environments. Input devices allow for cursor manipulation on a visual display screen of a personal computer or workstation, for example. Cursor manipulation includes actions such as rapid relocation of a cursor from one area of the display screen to another area or selecting an object on a display screen. Over years, input devices have evolved to include more functions not necessarily related to cursor position, such as browsing buttons “previous” and “next”, several functionalities associated with a wheel, and so on.

In a conventional opto-mechanical mouse environment, a user controls the cursor by moving the opto-mechanical mouse over a reference surface, such as a mouse pad so that the cursor moves on the display screen in a direction and a distance that is proportional to the movement of the opto-mechanical mouse. Typically, the conventional opto-mechanical mouse consisted of a mechanical approach where a ball is primarily located within the mouse housing and a portion of the ball is exposed to come in contact with the reference surface so that the ball may be rotated internally within the housing.

The ball of the conventional opto-mechanical mouse contacts a pair of shaft encoders. The rotation of the ball rotates the shaft encoders, which include an encoding wheel that has multiple slits. At least one light emitting diode (“LED”), or similar light source, is positioned on one side of the encoding wheel, while phototransistors, or similar photosensors, are positioned opposite to the LED. When the ball rotates, the rotation of the encoding wheel results in a series of light pulses, from the LED shining through the slits, that are detected by the phototransistors. Thus, the rotation of the ball is converted to a digital representation which is then used to move the cursor on the display screen.

The conventional opto-mechanical mouse detects displacement only when the ball moves relative to a surface (e.g., a table-top or mouse-pad). When such a mouse is lifted off the surface, the ball does not rotate, and thus no displacement is detected, even if the mouse is moved relative to the surface. Thus a user of such a conventional opto-mechanical mouse can easily reposition the mouse when needed (e.g., to re-center the cursor on the display, to readjust the position of the mouse when the end of the range of motion of a user's hand is reached, because the edge of the work surface is reached, and so on).

The conventional opto-mechanical mouse has drawbacks associated with many other devices that have mechanical parts. For instance, over time the mechanical components wear out, become dirty, or simply break down so that the input device can no longer be accurately used, if at all.

In response to several of these problems, optical input devices (such as mice and trackballs) have become increasingly common. Optical input devices use a displacement of an image to detect movement of the input device relative to a surface, e.g., a table surface in the case of a mouse or a ball in the case of a trackball. Optical input devices use a light source, illumination lens, an imaging lens, and a sensor to detect movement of the input device. Consider an optical mouse for purposes of the discussion here. An optical mouse measures the X-Y movement of the mouse relative to a work surface (e.g., table, mouse-pad, etc.), and maps this movement into the movement of the cursor on an associated display. However, in certain situations, the mouse may exhibit some X-Y movement relative to the work surface, but the user does not intend to map this movement into the movement of the cursor on the associated display. This happens when, for instance, a user lifts a mouse to for any reason. As mentioned above, a user may lift a mouse simply in order to move it, or to reposition it to a more convenient location, and so on. At such times, the user does not want the cursor to move based upon the movement of the mouse, but rather to stay stationary. In order for the cursor to stay stationary despite an X-Y change of the mouse relative to the work surface, the mouse has to be able to detect that it has been lifted. Unlike in the case of a conventional opto-mechanical mouse, such a lift is not automatically detected, but rather needs to be specifically detected. An algorithm can then be implemented that if lift is detected, the cursor on the associated display is not to be moved, regardless of any changes in the X and/or Y coordinates of the mouse.

Several attempts have been made to address these issues by detecting lift. A simple mechanical solution involves a mechanical plunger in the mouse, which, by virtue of gravity and/or a spring, drops down when the device is lifted, and which stays up when the mouse is resting on the work surface. However, such a solution has the usual problems associated with mechanical devices, which include for instance, the mechanical parts getting stuck, getting broken, becoming clogged with dirt, wear and tear, and so on. Other conventional methods of lift detection rely on an image to become unfocused in order to register a lift. This technique may not produce accurate results. For example, for highly contrasted surfaces with low resolution patterns, the surface remains in focus despite a lift, and thus a lift is not accurately detected.

Improving the performance of tracking further aggravates the lift detection problem, thus leading to a trade-off between lift and tracking. For instance, higher performance tracking implies detection of even small X-Y movements of the mouse, tracking over varied surfaces, etc. For instance, when a mouse is placed on a on a transparent on translucent surfaces (referred to hereinafter simply as “glass”), the tracking surface is either the glass itself, or a diffusing surface under the glass (e.g., a wooden table on which a glass sheet is placed). In the latter case, the thickness of the layer of glass, as well as various layers of air (e.g., the gap between the glass sheet and the table underneath) need to be taken into account. This is discussed in detail in co-pending applications Ser. Nos. 11/522,834 and 11/471,084, which are also assigned to the assignee of the present invention, and which are hereby incorporated by reference herein in their entirety. A long depth of focus is particularly desirable for detection of optical displacement on certain surfaces, such as when tracking on a diffusing surface placed beneath glass. For input devices with long depths of focus, the imaged area remains in focus despite lifts, again resulting in lifts not being detected accurately.

The fact that the mouse may already be a certain height above the tracking surface in such scenarios further complicates accurate lift detection, especially when even small lifts need to be detected. Beam triangulation can be used to determine when the device is lifted, and has been discussed in the above-mentioned co-pending applications. However, various components used in lift-detection (e.g., light source, sensor, etc.) are not optimized for lift detection, but rather for detection of optical displacement.

Another shortcoming of these various methods of lift-detection is that lift-detection is only measured as a function of received image quality. Therefore, such lift-detection algorithms often work well on some surfaces but not on others, and are dependent on the quality/type of surfaces. No direct height measurement is available, and tunability of lift detection by the user is also not possible.

Accordingly, there is a need for an input device that can accurately detect lifts relative to any surface, without impacting tracking performance, even for high-performance tracking systems. Further there is a need to be able to directly measure the amount of lift and/or determine the height of lift, and to allow the lift-detection to be tunable. Moreover, there is a need to optimize a lift-detection module in an input device.

### SUMMARY OF THE INVENTION

Embodiments of the present invention include a system and method that enables an optical device to accurately detect lift on any surface, even with improved tracking. Embodiments of the present invention to continuously and/or directly determine height of the lift from the surface, and allow the lift-detection to be tunable. Embodiments of the present invention allow for optimization of the lift-detection module in an input device.

Various methods are employed for lift-detection in accordance with embodiments of the present invention. Beam triangulation is one way in which lift of an input device can be detected. In one embodiment, confocal geometry with extended depth of focus is used. In accordance with one embodiment, a single light source is used. In accordance with one embodiment, multiple light sources are used. Thus the triangulation computations can be based on the movement of more than one spot (each spot corresponding to a light source), and thus more accurate lift detection is possible. In accordance with an embodiment of the present invention, an optically based lift detection module is separate from the optical tracking module. For instance, the light source and/or the sensor used for the lift-detection module are different from the light source and/or sensor used for the optical tracking engine. This facilitates independent optimization of components for purposes of lift detection and for purposes of tracking.

In accordance with an embodiment of the present invention, a capacitive lift detection technique is used. A capacitor is built into the bottom case of the mouse. When the mouse is resting on a surface, the surface material serves as a dielectric for the capacitor. When the mouse is lifted, air now serves as the dielectric for the capacitor. This change in the dielectric leads to a change in the value of the capacitance. This change in capacitance is measured/detected, and whether or not the mouse is lifted can be based on this. In one embodiment, the height of the input device above the work surface can also be measured—generally, when the input device is moving away from the work surface, high permittivity of the work surface is progressively replaced with lower permittivity of air.

In accordance with another embodiment of the present invention, a capacitor with an easily compressable material (e.g., foam) inserted between the two electrodes is used for lift detection. When the mouse is resting on the surface and is being used for cursor movement, the weight of the mouse and/or the user's hand compress the inserted material, thus creating a denser dielectric. When the mouse is lifted off the surface, the inserted material is no longer compressed, and the dielectric is rarified (e.g., the foam absorbs more air when not compressed). Further, the distance between the capacitor electrodes changes, due to the change in compression of the inserted material. This change in the dielectric material, along with the change in distance between the electrodes, results in a change in the measured capacitance, which is used to detect lift.

In accordance with an embodiment of the present invention, a mechanical plunger with an elastic membrane is used for lift detection. The mechanical plunger remains inside the mouse when the mouse is resting on the table, but protrudes from the mouse (due to gravity, a spring or other elastic material, etc.) when the mouse is lifted. An elastic membrane covering the plunger prevents dirt particles from contaminating the device, and can also be helpful in dealing with electro-static discharge (ESD). In one embodiment, an obturator activates/de-activates a switch used for lift-detection. In one embodiment, such an optical barrier can be obliquely placed between a source and a detector, thus allowing for progressive detection of lift.

In accordance with embodiments of the present invention, the detection of lift can be tunable and/or customizable by the user based upon his/her preferences. Furthermore, the height of lift can be detected. In accordance with embodiments of the present invention, a measurement of the height of the lift is used for various purposes not related to tracking of displacement of the input device relative to a surface. For instance, when an input device is lifted higher than a certain threshold off the surface, the “gestures” of the input device are used to perform commands and/or functions. As another example, lift and/or height detection can be used for power management purposes.

The present invention may be applied to many different domains, and is not limited to any one application or domain. Many techniques of the present invention may be applied to a different device in any domain. For instance, the input device under discussion may be a remote control used with a computer, or with devices in a user's entertainment system. Lift detection may be useful for remote controls for several purposes, such as power management. The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

The invention has other advantages and features which will be more readily apparent from the following detailed description of the invention and the appended claims, when taken in conjunction with the accompanying drawing, in which:

FIG. 1 is an illustration of a conventional computer system with an optical input device.

FIG. 2A illustrates lift detection using beam triangulation in accordance with an embodiment of the present invention.

FIG. 2B illustrates a graph of the spot shift against the height to which the optical device is lifted off the surface, in accordance with an embodiment of the present invention.

FIG. 2C is a flowchart which shows calibration of a height measurement system at manufacture time in accordance with an embodiment of the present invention.

FIG. 2D is a flowchart which shows the steps taken for height measurement when the device is being used after calibration, in accordance with an embodiment of the present invention.

FIG. 2E is a flowchart which shows steps taken for auto-calibration and height measurement in accordance with an embodiment of the present invention.

FIG. 3 illustrates a block diagram of an input device in accordance with the present invention, showing an optical displacement tracking module and a lift detection module.

FIG. 4 illustrates a mouse with a capacitor built into the bottom of the mouse case in accordance with an embodiment of the present invention.

FIG. 5 illustrates a mouse with a capacitor with a compressible material built into the bottom of the mouse case in accordance with an embodiment of the present invention.

FIG. 6A shows a mechanical plunger coupled to an elastic membrane in accordance with an embodiment of the present invention.

FIG. 6B shows an optical obturator coupled to an elastic membrane in accordance with an embodiment of the present invention.

FIG. 7A shows an optical barrier and obturator in accordance with an embodiment of the present invention.

FIG. 7B shows an oblique obturator in accordance with an embodiment of the present invention.

FIG. 8 is a flowchart which shows the modification of behavior of a device based upon various thresholds.

### DETAILED DESCRIPTION OF THE INVENTION

The figures (or drawings) depict a preferred embodiment of the present invention for purposes of illustration only. It is noted that similar or like reference numbers in the figures may indicate similar or like functionality. One of skill in the art will readily recognize from the following discussion that alternative embodiments of the structures and methods disclosed herein may be employed without departing from the principles of the invention(s) herein. It is to be noted that although the following description of the preferred embodiments of the present invention is presented in the context of an optical mouse, there are other devices that can use the present invention such as, for example, an optical scanner, an optical digital writing system (e.g., Logitech IO pen by Logitech, Inc. of Fremont, Calif.), and in some cases, even a conventional opto-mechanical input device.

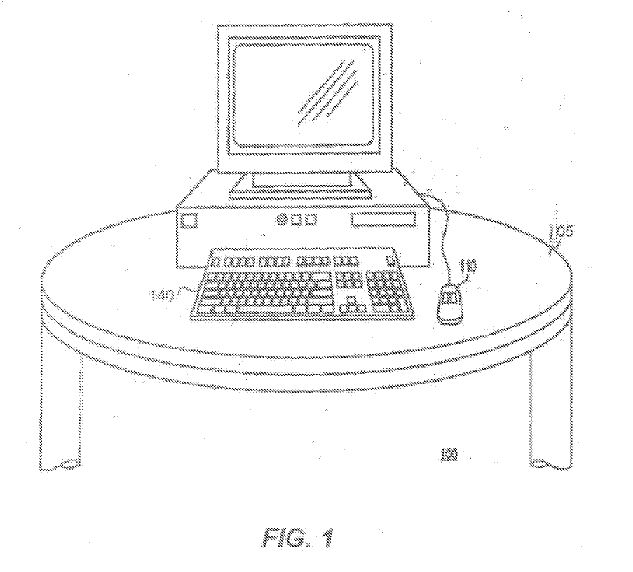

FIG. 1 shows a sample diagram of a conventional computer system 100 including two input devices, a keyboard 140 and an optical input device 110, resting on a working surface 105. One example of an input device 110 using optical displacement detection technology is an optical mouse. Examples of input devices using optical detection technology and their operation are described in U.S. Pat. No. 5,288,993 to Bidiville, et al. (issued Feb. 22, 1994) entitled “Cursor Pointing Device Utilizing a Photodetector Array with Target Ball Having Randomly Distributed Speckles” and U.S. Pat. No. 5,703,356 to Bidiville, et al. (issued on Dec. 30, 1997) entitled “Pointing Device Utilizing a Photodetector Array,” the relevant portions of which are incorporated herein by reference in their entirety. The working surface 105 may be a diffusing surface (e.g., wood, cloth, conventional mouse pads, etc.), a transparent/translucent surface (e.g., glass), a transparent/translucent surface placed on a diffusing surface (e.g., a glass sheet placed on a wooden table) and so on. It should be noted that although typically surface 105 is a flat surface, such as a mouse pad, table top, or the like it is not necessarily so. Surface 105 can be any surface, for example, a person's arm or hand, a sphere (as in a track ball input device), the arm of a chair or couch, or any other surface that can be placed in close proximity with the optical device 110.

An input device in accordance with various embodiments of the present invention implements different lift-detection techniques. Some of these lift-detection techniques are discussed below.

Beam Triangulation with an Optimized Lift-Detection Module

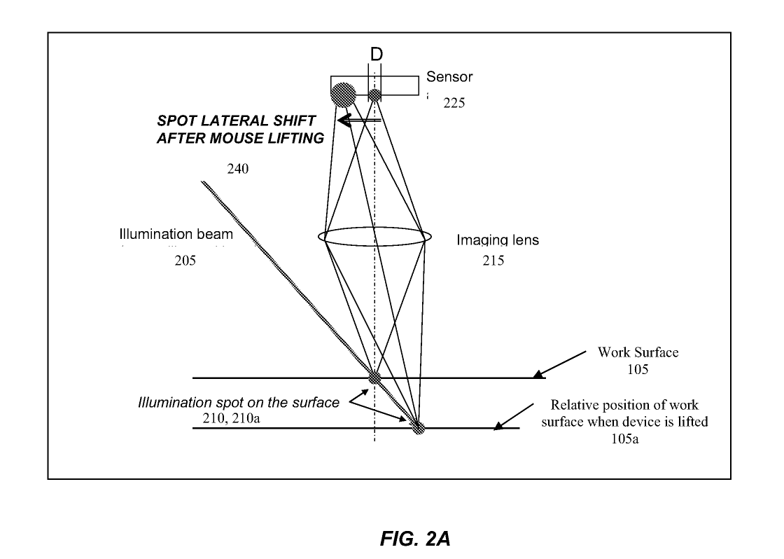

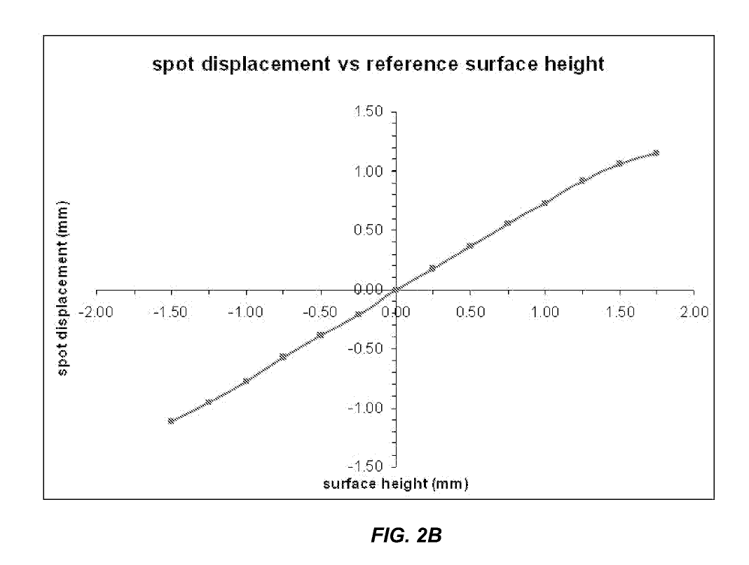

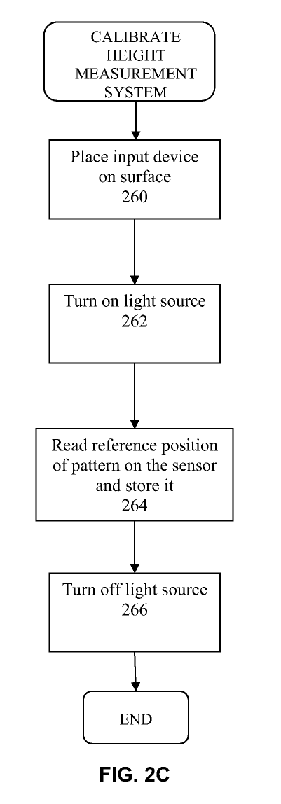

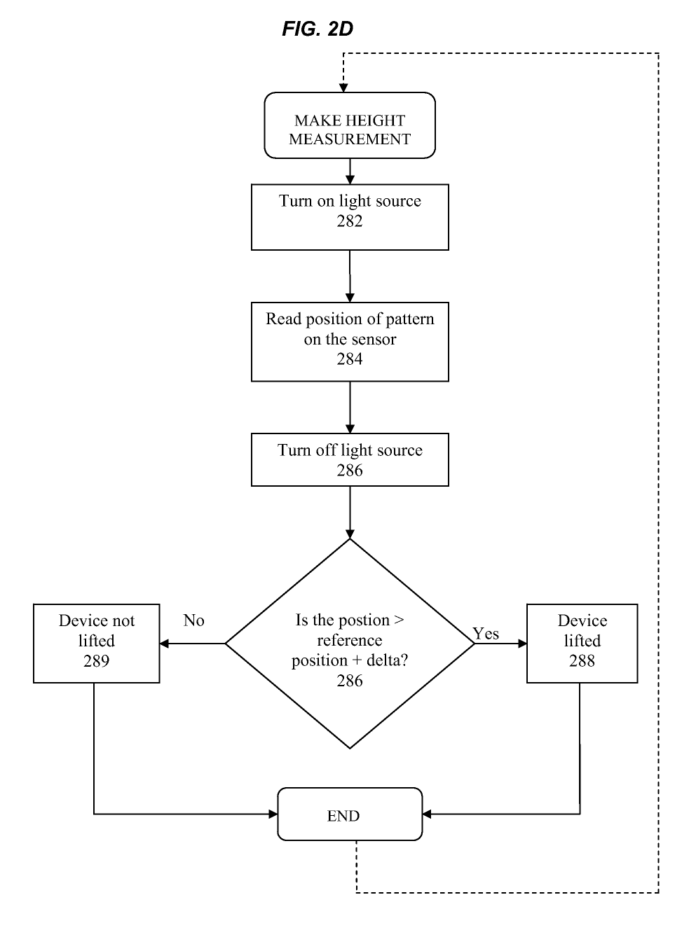

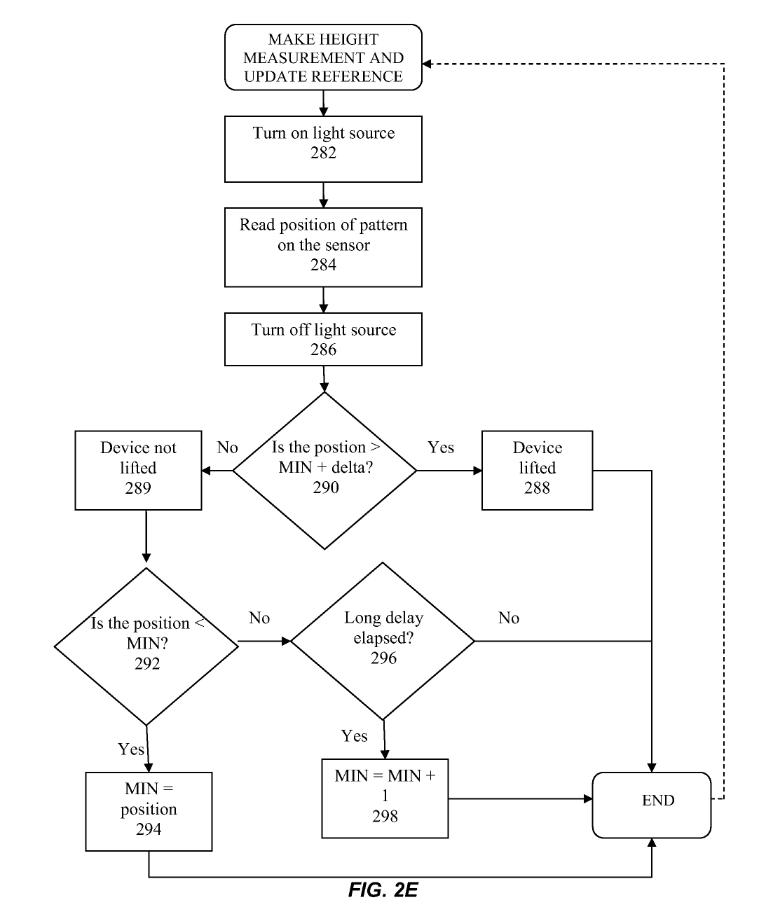

FIG. 2A illustrates how, in one embodiment, beam triangulation can be used for purposes of detecting when an input device 110 is lifted from a work surface 105. The work surface 105 under discussion here could be any surface. For instance, the work surface 105 can be an optically rough surface (e.g., wood, paper, etc.), or an optically smooth surface (e.g., glass). Alternately, the surface 105 could be an optically rough surface under an optically smooth surface (e.g., a wooden desk covered by a glass sheet).

In one embodiment, a light source (not shown) creates a bright spot in the middle of the field of view of the imaging system. In one embodiment, the light source is a Light Emitting Diode (LED) (e.g., IR LED). In one embodiment, the light source is a laser. It can be seen from FIG. 2A that when an illumination beam 205 is obliquely directed to a surface 105, (possibly using an illumination lens (not shown)), an illumination spot 210 is created. Light from this illumination spot passes through an imaging lens 215 and is detected as spot 220 on a sensor array 225. When the optical device 110 is lifted from the surface 105, the surface moves downwards relative to the optical device 110. This new relative position of the surface 105a is illustrated in FIG. 2. With this new relative position of the surface 105a, the illumination spot 210a is formed in a different position. Light from this illumination spot 210a also passes through the imaging lens 215 and is detected as spot 220a on sensor array 225. It can be seen from FIG. 2A, that when the optical device 110 is lifted off the surface 105, there is a lateral shift 240 in the spot formed on the sensor. It is to be noted that, in accordance with an embodiment of the present invention, the illumination beam 205 (and possibly also the imaging) has to be at an angle to the work surface 105, if the shift of the illumination spot is to occur.

Any method may be to evaluate the spot position on the sensor 225. Some such methods include, but are note limited to: 1. feature extraction and detection of feature position (for example feature can be that response to incoming intensity is substantially above dark pixel response (non-zero pixel feature); 2. boundary non-zero pixel (first illuminated pixel to emerge from neighboring dark pixel); 3. the illumination has an easily detectable pattern like a cross using for example a DOE and a laser. This pattern is partly reproduced on the spot image so as to be recovered and its position estimated; 4. center of gravity of spot can be a feature; 5. center of gravity of a non-linear transform of the spot image, and so on.

In one embodiment, optical device lifts are detected when the spot lateral shift is larger than a specific distance on the sensor array (which, in one embodiment, can be linear). In one embodiment, this specific distance is predetermined. In one embodiment, a magnification factor G<1 may be used to reduce the range of the lateral shift (i.e. the size of the detector array).

FIG. 2B illustrates a graph of the spot shift 240 plotted against the height to which the optical device 110 is lifted off the surface 105, in accordance with an embodiment of the present invention. It is to be noted that the graph will change depending on several factors, such as the optics used (e.g., the light source, sensor, etc.) for lift detection, the incidence angle of the light beam, etc.), and so on. Height of the input device 110 from the surface 105 can thus be directly determined.

Before the input device 110 can be used for height detection, it needs to be calibrated. Calibration can occur either at the time of manufacturing, or at the time the device is used. FIG. 2C is a flowchart which shows calibration of a height measurement system at manufacture time in accordance with an embodiment of the present invention.

In accordance with an embodiment of the present invention, the input device 110 is placed (step 260) on a surface 105. A light source to be used for height detection is turned on (step 262). The position of the received pattern at the sensor 225 is recorded (step 264) as a reference position. In one embodiment, the value of the initial location of the pattern on the sensor 225 is memorized in an EEPROM. The light source is then turned off (step 266).

Once the input device 110 has been calibrated at manufacturing, the device 110 can be used to measure its height above a surface 105 during its use. FIG. 2D is a flowchart which shows the steps taken for height measurement when the device 110 is being used after calibration, in accordance with an embodiment of the present invention. The light source is turned on (step 280), and the position of the pattern on the sensor is read (step 282). The light source is turned off (step 284). A determination is made (step 286) regarding whether the new position of the pattern read on the sensor is greater than delta (a threshold) away from the reference position recorded during calibration. (The threshold can prevent false detections of lift, etc. In one embodiment, the threshold can have slightly different values, when the input device is lifted off the work surface and when it is resting on the work surface.) If so, it is determined that the device is lifted (step 288), otherwise it is determined that the device is not lifted (step 289). In one embodiment, steps 282-298 are repeated after a specific time interval. The dotted line shows that the these steps for height measurements are performed after certain time intervals as part of the idle loop of the firmware. The exact time between measurements may be variable, and is chosen based on several parameters such as whether or not the device is already registered as being lifted, the movements of the input device, activation of various switches, time since last movement, and so on.

In accordance with another embodiment, no calibration is done during manufacture of the device 110, and the calibration occurs during the use of the input device 110. FIG. 2E is a flowchart which shows the steps taken for such auto-calibration and height measurement in accordance with an embodiment of the present invention. When the device 110 is being used, as mentioned above with reference to FIG. 2D, the light source is turned on (step 282), the position of the pattern on the sensor is recorded (Step 282) and the light source is turned off (step 286). However, since no calibration has occurred during manufacturing in this embodiment, there is no stored reference position of the pattern on the sensor with which this position can be compared. Instead, a MIN value is established, and the position of the pattern on the sensor is compared (step 290) to this MIN plus a threshold value (delta). In one embodiment, the initial value of MIN is the first value read from the sensor. In this case the function will not work correctly until the mouse has been put on the work surface at least once. An alternative is to take an arbitrary value close to the average switching point of a large number of units (frozen in the firmware). Yet another alternative is to keep a value from previous period of operation and store it in non volatile memory. In this case the requirement to place the mouse on the work surface to start the proper working of the lift detection will happen only the first time the mouse is powered during test after manufacturing. As for the embodiment shown in FIG. 2D, in this case also, delta prevents noise from affecting the result by defining the small lift required to trigger the lift detection. If the position is separated from MIN by more than delta, then it is determined (step 288) that the device 110 is lifted. If not, it is determined (step 289) that the device 110 is not lifted. In one embodiment, MIN determines height=0. Then all the other heights are derived from MIN by adding a number to it. When MIN changes, all the other follow and are them adapted to the latest conditions.

The principle of such an auto-calibration algorithm is based on the continuous updating of the MIN value when the input device 110 is on the surface 105. Thus if it is determined (step 289) that the device is not lifted, it is determined (step 292) whether the position is less than MIN. If so, the value of MIN is set (step 294) to the position. If not, it is determined (step 296) whether a long delay has elapsed. The purpose of the increment and the long delay is to prevent a wrong value from being memorized for ever and locking the system. The “long delay” is long enough so that, even if the mouse remains lifted for a very long time, it will not appear as resting on the surface again. If the input device is determined (step 289) to be not lifted, and it is determined (step 296) that a long delay has elapsed, then MIN is incremented (Step 298 by 1). This way the value of MIN is continuously adjusted to a kind of optimum value, and tracks evolution of all the variables that can affect the measurement—both those that tend to increase its value and those that tend to decrease it. As in FIG. 2D, the dotted loop line is used to show the repetition of the sequence at variable time intervals in function of the same parameters as above. It is to be noted that in one embodiment, the methods of defining thresholds can be adapted to the type of systems and methods that provide a measurement of the height of the mouse. These height detection systems and methods are discussed throughout this application (e.g., triangulation, capacitive, plungers, etc.)

The calibration for the above embodiments can be performed in hardware, software, and/or firmware. In yet another embodiment, no calibration is performed. In yet another embodiment, calibration at manufacturing is performed, and then auto-calibration is also employed.

It is to be noted that rather than simply detecting lift (step 288) or not detecting lift (step 289), in one embodiment, the amount of lift is measured, by translating the shift of the spot into the height of the device 110. Various uses of the information relating to the height of lift are discussed below. An example of the relationship between the shift of the spot and the amount of lift is provided above in FIG. 2B.

In one embodiment, multiple light sources are used in a single optical device 110. Further, the light sources used can be coherent (e.g., lasers) or incoherent (e.g., LEDs). The use of multiple light sources for detecting displacement has been discussed in detail in co-pending applications Ser. Nos. 11/522,834 and 11/471,084, assigned to the assignee of the present invention, and which are hereby incorporated herein in their entirety. Multiple light sources can be used for lift detection purposes as well. For instance, each light source will produce a spot which will get laterally shifted when the optical device 110 is lifted off surface 105. One or more of these shifts can be used, in accordance with an embodiment of the present invention, for purposes of lift detection. For example, the average of the shifts of the various spots can be used as the metric for lift detection. Using multiple light sources can extend the measured height range of lift. In one embodiment, multiple LEDs are used, with each LED having a slightly different incidence angle. The ranges of the different LED will correspond to different height ranges (with some possible overlap). In one embodiment, the multiple light sources have different wavelengths of light. Other benefits of multiple light sources include an increase in precision of lift detection, detection of lift regardless of tilt, and so on. In one embodiment, one light source is used to determine optical displacement along the X-Y dimension relative to the surface, while another light source is used to determine the height of a lift relative to the surface. In one embodiment, a single sensor can be used.

It is to be noted that in accordance with various embodiments of the system, one or more illumination lenses (not shown in FIG. 2A) can be used. In addition, one or more imaging lenses 215 can be used. In one embodiment, an imaging lens and illumination lens are included in a single physical item. In yet another embodiment, no illumination and/or imaging lenses are used. It is also to be noted that while a sensor 225 is shown as a sensor array in FIG. 2A, several different types of sensors may be used in accordance with embodiments of the present invention. For instance, a sensor 225 can be single photo-transistor, can be made up of multiple single elements, can be a one dimensional pixel matrix (a linear array), an be a two dimensional pixel matrix, can be position sensing device, and so on. It is also to be noted that while the discussion above focused on the creation of a spot 210. 210a, the light can form any pattern on the surface 105 other than a spot. Furthermore, various arrangements of various optical components are possible. For instance, the light source and the sensor 225 can be arranged in a specular configuration in one embodiment.

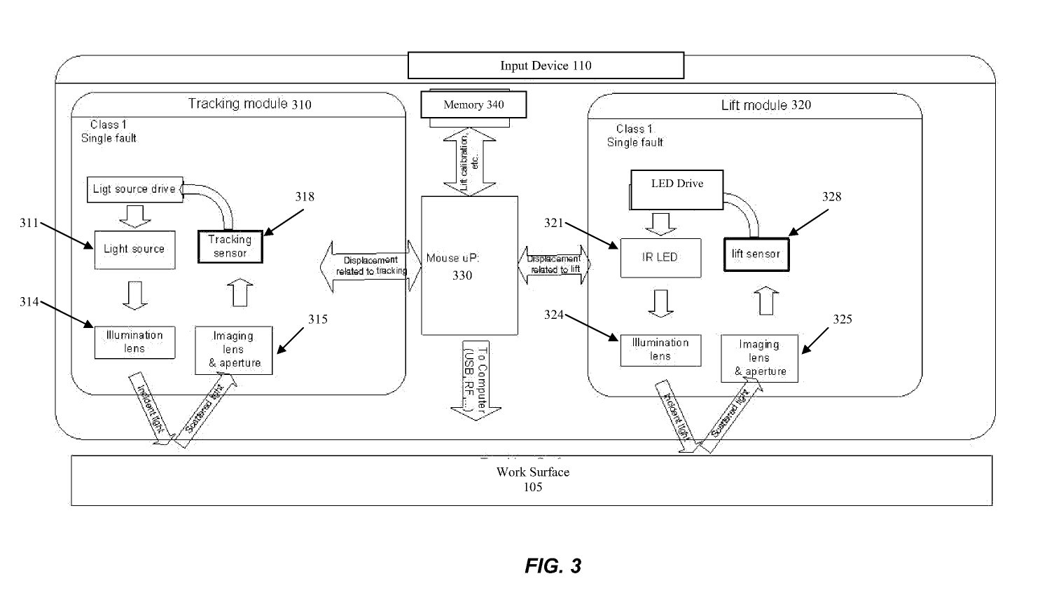

In one embodiment, a module used for lift detection is separate from the module used for detection of displacement. Such an embodiment is illustrated in FIG. 3. It can be seen from FIG. 3 that the optical input device 110 has an optical tracking module 310, and a lift-detection module 320. The optical tracking module 310 (alternately referred to as an optical displacement detection module) includes a light source 311, an illumination lens 314, an imaging lens 315, and a sensor 318. The optical tracking module 310 is used to detect X-Y displacement relative to surface 105, which is translated into movement of the cursor on the associated display. The lift detection module 320 includes a light source 321, an illumination lens 324, an imaging lens 325, and a sensor 328. In one embodiment, a light source drive is included in either or both modules 310 and 320. In one embodiment, the lift detection module 320 is used for directly measuring height (Z-distance) of the optical input device 110 from the surface 105. In one embodiment, this measurement of height is direct, rather than being based upon analysis of the quality image captured by the sensor, as is done in prior art. Basing the estimation of lift of the analysis of image quality necessarily makes this estimation dependent on the quality of the tracking surface, which is not the case with embodiments of the present invention. In one embodiment, such lift/height detection is based upon beam triangulation as discussed above.

Information is provided by the optical tracking module 310 and the lift-detection module 320 to micro-processor 330. Some information (such as calibration information) is stored, in one embodiment, in memory 340. Memory 340 may be, for example, and EEPROM.

The translation of the output of the optical tracking module 310 into cursor movement (or the output of the optical tracking module 310 itself) is calibrated based upon the output of the lift-detection module 320. For instance, if a lift is detected, in one embodiment, there is no movement of the cursor even if there is an X-Y displacement relative to the surface 105 detected by the optical tracking module 310. In one embodiment, the lift detection module 320 provides information on the amount of lift (or height) relative to the surface 105, and this amount of lift is used to optimize the cursor movement. For example, in one embodiment, when a lift is detected, this translates into no cursor movement. In another embodiment, when a lift is detected, this translates into cursor movement scaled by a factor.

It is to be noted that in different embodiments, each of these modules 310, 320 have one or more light sources, one or more illumination lenses, one or more sensors, one or more imaging lenses, and so on. It is to be noted that one or more components described (e.g., illumination and/or imaging lenses) may not be included at all in modules 310 and/or 320. Further, it is to be noted that several components included in the optical device 110, such as micro-processors, PCBs, etc. are not shown in FIG. 3 so as to reduce confusion and clutter.

It is to be noted that in some embodiments, some components described above (e.g., illumination lens, imaging lens, sensor, etc.) are shared by the optical tracking module 310 and the lift detection module 320. For instance, a 2D sensor used by the optical tracking module 310 could also be used by the lift-detection module 320.

Having separate modules 310, 320 for optical tracking and lift detection allow each of these functions to be optimized. For instance, a laser light source may be desirable for accurate optical tracking, while an LED may be desirable for accurate lift detection. Other changeable parameters for light sources include the wavelength of the light source, the angle at which the light source is positioned, etc. In one embodiment, if the same area of the work surface 105 is used for both the displacement tracking and height measurement, the cycles of height measurement and displacement measurement have to be interleaved such that both light sources 311 and 321 are not ON simultaneously. If multiple light sources are used for lift-detection, as mentioned above, these light sources may also be switched on alternately.

The optimum size and/or shape of the sensor may be different for purposes of optical tracking versus for purposes of lift detection. For instance, the sensor 318 used for the optical tracking module 310 needs to be a two-dimensional array, in order to detect displacement in both the X and the Y directions. However, the sensor 328 used for the lift-detection module 320 may only be one-dimensional (a linear array), in order to detect the lateral shift 240. In one embodiment, the sensor 328 used in the lift-detection module 320 is a linear array of photo-transistors. Such a linear array makes it possible to accurately measure the height of the optical device 110 from the surface 105, rather than having a single photo-sensor (e.g., photo-transistor) as sensor 328. Measurement with a single photo-transistor 328 requires a comparison of the photocurrent with a fixed reference to decide if the mouse is lifted or not. The consequence is that it is not possible to measure the height because the photo current will depend on the characteristics of the work surface 105. Also “lift” will be detected at different distances from the table depending on the characteristics of the work surface 105. In accordance with embodiments of the present invention, multiple photo-transistors are used in sensor 328 (e.g., a linear array). This allows for measuring shift/movement of the spot center, thus allowing for real height measurement, and for lift detection independent of the work surface 105 characteristics.

In one embodiment, confocal optics are included to further improve determination of height of the optical device 110. One example of optics optimized for lift detection include optics in confocal geometry with extended depth of focus. As mentioned above, the determination of height of the optical device 110 from the surface 105 provides not only a binary determination of whether or not a lift has occurred, but also an indication of the amount of lift, thus making it possible to tune/customize the lift algorithm as discussed below.

In one embodiment, this row of phototransistors are read by the microprocessor in the optical device 110, and the position of the spot is computed before making the decision if the mouse is lifted or not, by how much it has been lifted, and so on. This solution is very low cost to implement. In another embodiment, an ASIC is used to perform the calculation and provide the result regarding whether or not the mouse has been lifted, how much it has been lifted by, and so on. In one embodiment, the height measurement can be more precise than the pitch of the photo-transistors making up sensor 328, based upon interpolation. The spot image on the sensor 328 needs to cover two photo-transistors or more to allow interpolation. In one embodiment, interpolation is performed by measuring the center of gravity of the spots.

In one embodiment, the lift sensor 328 should be as close as possible to the tracking sensor 318, so as to minimize a mismatch in lift condition between the two.

In one embodiment, the positioning of the lift-detection module 420 within the input device 110 can be optimized. For instance, users often lift the front end of the mouse 110, while the back-end is not lifted at all, or not lifted as high of the surface as the front end. This may be because it is ergonomically more convenient and quick to simply lift the front end of an input device 110. To effectively register such a front-heavy lift, the lift-detection module 420 is positioned toward the front end of the input device 110 in accordance with an embodiment of the present invention.

In one embodiment, the bottom case of the input device 110 is a continuous base, as discussed in co-pending application Ser. No. 11/240,869, entitled “Continuous Base Beneath Optical Sensor and Optical Homodyning System”, which was filed on Sep. 29, 2005, which is assigned to the assignee of the present application, and which is hereby incorporated by reference herein. In more general terms, referring to FIG. 2A, it is possible to have an intermediate surface between 215 and 105. Such an intermediate surface (such as the bottom case of the mouse) will not prevent the lift module from functioning properly, as long as it is not opaque to the light source chosen.

### Capacitive Lift-Detection

In accordance with an embodiment of the present invention, rather than using an optical solution for lift detection, a capacitive lift-detection technique is used. A capacitor changes value when a mouse 110 is on the surface 105 compared to when it is lifted. By measuring this change in capacitance, it is possible to know lift status (and sometimes also the height/distance of the device 110 from the surface 105).

In several embodiments, the capacitor is quite small and the best way to measure it is by charge transfer. In one embodiment, an unknown capacitor Cx is charged, and its charge is then transferred into a larger accumulating capacitor Cs. This cycle is repeated until the voltage on the accumulating capacitor Cs reaches a threshold. The number of cycles is inversely proportional to the value of the unknown capacitor. In one embodiment, the user can set a number of transfer cycles that correspond to the lifted condition. Algorithms similar to those described in FIGS. 2C and 2D can be used for threshold determination.

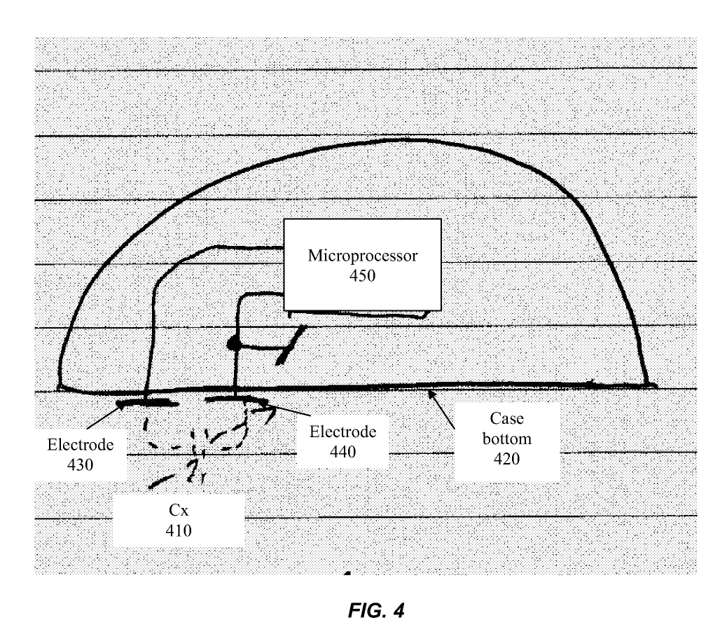

FIG. 4 illustrates a mouse 110 with a capacitor Cx 410 built into the bottom 420 of the mouse case in accordance with an embodiment of the present invention, coupled to a microprocessor 450. Capacitor 410 includes electrodes 430 and 440. In one embodiment, the mouse case bottom 420 includes a printed circuit with two interleaved electrodes (not shown). Interleaving provides an advantage of a larger capacitance value without requiring large electrode surfaces. In one embodiment, the electrodes are not interleaved. In one embodiment, the electrodes (whether interleaved or not) are in the same plane, and are as close as possible to the work surface 105. In one embodiment, the electrodes are surrounded by materials with low permittivity (e.g., air or foam). In one embodiment, the thickness of the PCB should be made as small as possible, so as to make the capacitance change between the lifted position and on the work surface position as large as possible, even if the work surface 105 is covered with relatively low permittivity material.

The microprocessor 450 measures the changes in capacitance. An example of microprocessor 450 is QT 1xx made by Quantum Research Group (Hamble, UK). When the mouse 110 is resting on the surface 105, the surface material serves as a dielectric for the capacitor Cx 410. When the mouse 110 is lifted, air now serves as the dielectric for the capacitor Cx5 410. This change in the dielectric leads to a change in the value of the capacitance. This change in capacitance is measured/detected, and whether or not the mouse 110 is lifted can be based on this. To maximize the change in capacitance, in one embodiment, the electrodes 430, 440 are “insulated” from the mouse case by a layer of (rigid) foam (not shown).

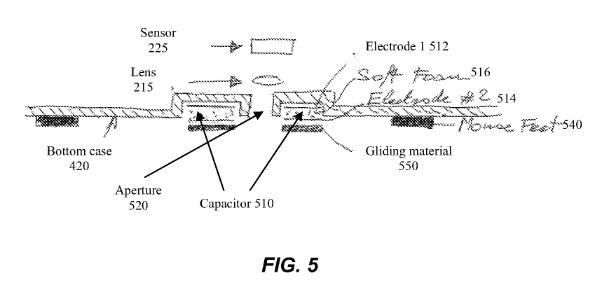

As can be seen in FIG. 5, in accordance with another embodiment of the present invention, a capacitor 510 with an easily compressable material 516 (e.g., foam) inserted between the two electrodes 512, 514 is used for lift detection. In the embodiment shown, the capacitor 510 is placed as a ring around aperture 520 in the bottom case 420. This ring capacitor around the aperture 520 is a ring around the displacement sensor 318 axis, in accordance with an embodiment of the present invention. Mouse feet 540 and a friction reducing material 550 (e.g., Teflon) which may be used to cover the capacitors 510a, 510b are also visible in FIG. 5.

When the mouse 110 is resting on the surface and is being used for cursor movement, the weight of the mouse and/or the user's hand compress the inserted material 516, thus creating a denser dielectric, and a larger capacitance. In addition, the electrodes 512, 514 also get closer to each other when the inserted material is compressed with the weight of the mouse 110 and/or the user's hand, thus further increasing the capacitance. When the mouse 110 is lifted off the surface, the inserted material 516 is no longer compressed, and the dielectric is rarified (e.g., the foam absorbs more air when not compressed), and the electrodes 512, 514 move further apart, thus decreasing the capacitance. This change in the value of the capacitance, is used to detect lift and/or to measure the extent of the lift.

In one embodiment, the capacitor 510 could be placed on top of the displacement sensor, so that the compression and expansion of the foam 516 have no effect on the height of the mouse 110. This would also protect the mouse 110 from electrostatic discharge (ESD). In one embodiment, the sensor is flexibly mounted as described in U.S. Pat. No. 6,788,875.

The configuration described with reference to FIG. 5 also allows for height measurement (limited by the amount of compression of the inserted material 516). The value of the capacitor Cx 510 is affected by the foam 516 between the electrodes 512, 514. All the other variables such as the characteristics of the work surface 105 have only a minor effect and can be neglected.

Lift/Height Detection with Elastic Membrane

In one embodiment, lift detection is performed using a mechanical plunger covered with an elastic membrane. The membrane completely closes the bottom case opening (sealed). The membrane can be made of rubber or other like material. It can also be made of other foil that is preformed or molded with a bellows area so that some vertical movement is possible in the center.

In one embodiment, there are elements attached to both sides of the membrane. On the lower side, there is a friction surface, similar to the gliding material 550 on the mouse feet described above. This will prevent the membrane from being punched through by wear and a path for ESD being opened. On the upper side of the membrane, in accordance with an embodiment of the present invention, there is some extension for interfacing with the plunger. These elements can be attached to the membrane by various means, such as adhesive, ultrasonic welding, overmolding, etc. making sure there is no hole through the membrane. The membrane is attached to the mouse case bottom in a similar way.

In one embodiment, a mechanical plunger is used in conjunction with an elastic membrane. The mechanical plunger remains inside the mouse 110 when the mouse is resting on the table, but protrudes from the mouse (due to gravity, a spring or other elastic material, etc.) when the mouse is lifted. While several of the drawbacks associated with mechanical solutions remain (e.g., noise, jamming/breakage of parts, mechanical wear and tear), the elastic membrane covering the plunger prevents dirt particles from contaminating the device, and can also be helpful in dealing with electrostatic discharge (ESD). The membrane can be made, for example, of thin plastic, rubber, etc. Alternately, it can include an enlarged friction surface covered with low friction material, or include a very hard material like hardened steel, ceramic or ruby and so on.

In one embodiment, the user can manipulate the mechanical plunger (e.g., by using a user button to pull the plunger into the mouse). For instance, the user can push the plunger inside the mouse, which activates a switch, for mouse on-off functionality for instance.

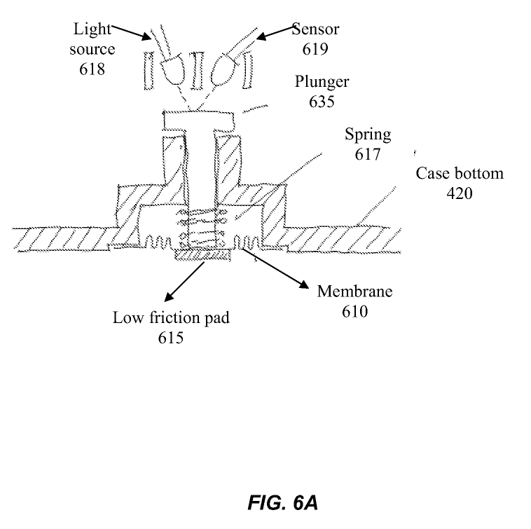

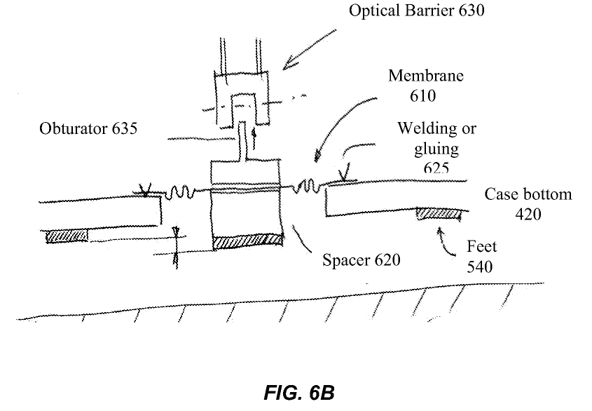

FIG. 6A shows an embodiment of an input device 110 with a plunger 635. The input device 110 includes an elastic membrane 610 coupled to the plunger 635. A light source 618 and a light sensor 619 are also shown. Light emitted by the light source 618 is reflected off the top of the plunger 635, and received by sensor 619. In one embodiment, the reflective sensor 619 is always facing the same surface. This makes it possible to measure the distance as a function of the current received by the sensor 619. Such measurements are then repetitive and independent of the work surface 105 characteristics.

In one embodiment, a component such as spring 617 is included. In another embodiment, no spring (or such component) 617 is included. In one such embodiment, the elastic membrane 610 provides enough return force for the plunger 635 to move. As mentioned above, in one embodiment, a low-friction pad 615 is placed underneath the elastic membrane 610.

FIG. 6B shows an embodiment of an input device 110 in accordance with an embodiment of the present invention including an optical barrier. A flexible membrane 610 with a bellows section allows the movement of the center area in order to activate a sensor or switch. A spacer 620 protruding below the bottom case 420 of the mouse 110 by some distance (e.g., 1 mm) is required in one embodiment, so that when the mouse 110 is placed on the work surface 105, the center part of the membrane 610 is pushed up into the mouse 110, and this activates the switch or other sensor. In the embodiment shown in FIG. 6, the switch is implemented using an optical barrier 630 and obturator 635.

In one embodiment, when seen from the bottom, the shape of the membrane 610 is circular. In one embodiment, placing the membrane 610 at the level of the upper surface of the bottom case 420 allows the joint 625 of the membrane 610 (e.g., welding or gluing area) to be hidden. In order for such a placement of the membrane 610, a thicker spacer 620 on the bottom side is required.

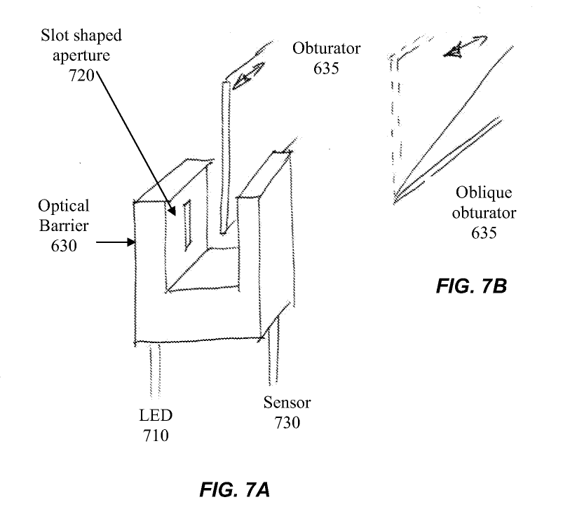

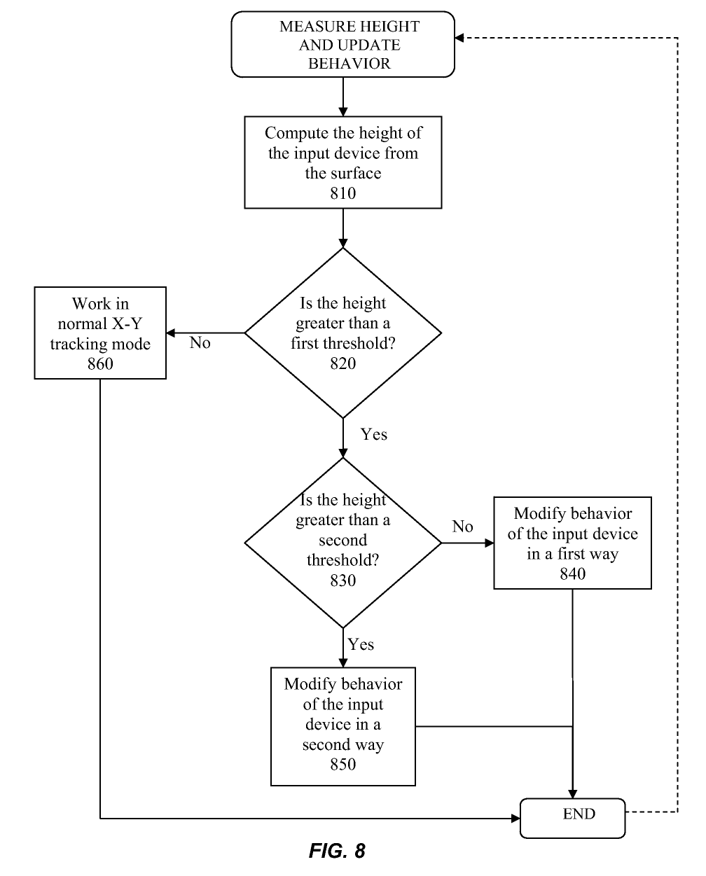

FIG. 7A shows a typical optical barrier 630 and obturator 635 in some detail. In front of the LED (or any other type of light source) 710, there is a slot shaped aperture 720. In one embodiment, when a digital output is required, the edge of the obturator 635 is parallel to the length of the slot. Thus the light received by the sensor 730 varies very sharply over a small travel of the obturator 635 equal to the width of the slot 720 (e.g., 0.3 mm or less). In an alternate embodiment, if some height of lift measurement capability is required, it is possible to have an oblique edge on the obturator 635 as shown in FIG. 7B, so that a much larger movement is required to change the light received by the sensor 730 from 100% to 0. In another embodiment, if an analog value is needed, a PSD or a linear array is used as the sensor 730 instead of a single phototransistor.

In another embodiment, instead of using a barrier, a simple reflective opto-sensor can be used, light being reflected by the upper side of the membrane or an additional part attached to it. This is simpler to assemble than the oblique obturator 635.

Several variations on the above principle are possible. For instance, the position of the plunger can be determined in one of several ways, including, but not limited to using an optical barrier, a micro-switch, a magnet and magnetic sensor (e.g., Hall, magneto-resistive, Reed switch, etc.), a foil switch or a Force Sensitive Resistor (FSR). In one embodiment, an optical barrier can be obliquely placed between a source and a detector, thus allowing for progressive detection of lift (height measurement).

It is to be noted that embodiments using a membrane based solution operate independently of the characteristics of the work surface 105. For instance, with an obturator 635, the characteristics (e.g., color, etc.) of the moving part is always the same, allowing a simple calibration and a more precise and consistent distance measurement.

### Tunability/Customization/Height-Detection

As discussed in numerous places above, the lift-detection implemented using some or all of the techniques described above can be tuned and/or customized. Moreover, the amount or degree of lift off the surface 105 can be detected. In accordance with embodiments of the present invention, a measurement of the height of the lift is used for various purposes not related to tracking of displacement of the input device relative to a surface.

In one embodiment, this determination of the amount of lift can then be used to customize lift detection. For instance, one or more parameters or thresholds may be set, where a lift is not registered if the amount of lift from the surface 105 is less than the threshold. One example of an appropriate threshold would be one which mimics the lift function in an opto-mechanical mouse, which has been discussed above. For example, in one embodiment, lifting the mouse 110 by 1 or 2 mm results in the mouse 110 not sending displacement reports. On the other hand, the mouse 110 does not stop sending displacement reports when lifted by 0.1 mm, because such small lifts being detected will result in the variations of the work surface 105 appearing as lifts. In one embodiment, such a threshold is defined by manufacturers of the input device 110. In another embodiment, such a threshold is defined by a user. This provides the users of the optical device 110 with the ability to customize lift-detection for the input device 110.

Rather than having a threshold, in accordance with an embodiment of the present invention, more refined tuning is also possible. For example, different scaling factors may be applied to the X-Y displacement detected, based upon the height of the input device 110 relative to the surface 105. It is to be noted that the X-Y displacement can be detected in any manner (e.g., optical, opto-mechanical, purely mechanical, etc.), and the lift can also be detected in any manner (e.g., beam triangulation, capacitive lift detection, mechanical plunger etc.).

Customizability/Tunability of lift-detection is particularly useful in certain scenarios, such as those involving uneven surfaces, and those involving use of the input device 110 for gaming.

Further, such customizability/tunability of the input device 110 can be used for purposes other than optimizing the X-Y movement of the cursor on an associated display. In one embodiment, the behavior of the input device 110 can be modified differently, depending upon the height of lift off the surface 105. A flowchart illustrating this is shown in FIG. 8. The height of the input device above the surface 105 is computed (step 810). It is then determined (step 820) whether this height is greater than a first threshold. If not, work in the normal X-Y tracking mode is resumed (step 860), and, as indicated by END and the dotted lines, the height of the input device above the surface is again computed (step 810) after a time interval, as discussed above.

If the height of the input device 110 from the surface 105 is greater than the first threshold, it is determined (step 830) whether this height is greater than a second threshold. If it is determined that the height is not greater than the second threshold, the behavior of the input device 110 is modified (step 840) in a first way. For instance, the first modification can be registering a lift, and optimizing the movement of the cursor (e.g., not moving the cursor on an associated display, even if the input device moves relative to the surface 105 in a plane parallel to it). If it is determined (step 830) that the height is greater than the second threshold, the behavior of the input device 110 is modified (step 850) in a different way. For instance, in one embodiment, such tunability is useful for a device that can operate both on a surface and in air. Such a device is described in co-pending application Ser. No. 11/455,230, entitled “Pointing Device for Use in Air with Improved Cursor Control and Battery Life”, filed on Jun. 16, 2006, and which is assigned to the assignee of the present invention, and which is hereby incorporated by reference herein in its entirety. As mentioned above, a lift greater than the first threshold but smaller than the second threshold can be used to operate the device as a surface device and register lifts. When the amount of lift is large (e.g., greater than the second threshold), a lift is not registered, but instead this large amount of lift is used as a trigger to register that the device is now operating in the in-air mode.

In one embodiment, additional thresholds can be set. For instance, let us consider 3 height thresholds T1, T2, and T3, where T3>T2>T1. In one embodiment, when the height of the input device 110 is less than T1 from the surface, no action is taken. When the height of the input device 110 is greater than T1 but less than T2, a lift is registered, and the cursor movement generated by the X-Y displacement of the input device 110 is optimized (e.g., zeroed out). When the height of input device 110 is greater than T2 and less than T3, some non-tracking action is taken. Examples of such non-tracking actions are provided elsewhere. When the height of the input device 110 is greater than T3, a different algorithm for tracking movement of the control device may be implemented, such as the in-air algorithms discussed in co-pending application Ser. No. 11/455,230, which is incorporated herein by reference.

The height of the input device 110 is continually computed (step 810) after some time interval, as discussed above.

Other uses of such lift-detection include power management—for instance, when a certain threshold of the amount of lift is exceeded, it can be determined that the input device 110 will not be immediately used for cursor control purposes, and unnecessary modules (e.g., the optical tracking module) can be turned off. Further, such modules can then be turned on when the amount of lift reduces, implying that the optical device is approaching a surface 105 and may therefore be shortly used. Thus the power management will be seamless, and not interfere with the user's use of the input device 110.

Some examples of non-tracking actions associated with height detection include different actions that can be taken based upon the amount of lift. For instance, in accordance with an embodiment of the present invention, a visual feedback may be provided to the user indicating the amount of lift of the input device 110 (for example by having different pointer shapes corresponding to different height levels, LED indicators, bar graphs, and so on). In other embodiments, specific actions may be taken depending on the software application the user is using, based upon the amount of lift detected (e.g., a trigger event can be assigned to an application control). For instance, when slightly lifted, the input device 110 pans the associated display instead of moving the cursor. In one embodiment, the cursor shape automatically changes from the arrow to the hand icon.

Yet other examples of the applications of height detection include using the “gestures” (e.g., panning, zooming, etc.) of the input device are used to perform commands and/or functions (e.g., changing the volume based etc). Examples of such gestures are included in co-pending application Ser. No. 11/455,230 incorporated herein by reference above.

Other examples of applications of tunability include specific uses of the input device 110, such as use of the input device 110 for gaming purposes. Gamers desire very fast reaction time. In order to allow for faster re-centering of the cursor, gamers can reduce the trigger height to register as a lift. It is to be noted that this list of applications of the customizability/tunability of lift detection is not meant to be exhaustive, but merely illustrative. Still another example of applications of tunability/customizability includes using height information in a control loop for an adaptative optics, for instance in case of a configurable mouse whose exact shape (and incidentally height of the tracking system) is set by the user.

While particular embodiments and applications of the present invention have been illustrated and described, it is to be understood that the invention is not limited to the precise construction and components disclosed herein. For example, an input device in accordance with embodiments of the present invention can be a remote control used to control components of the user's multi-media system (e.g., a TV, DVD player, etc.). As another example, any of the above-mentioned lift-detection methods (e.g., capacitive lift detection) can be combined with aspects of other methods (such as an elastic membrane). Various other modifications, changes, and variations which will be apparent to those skilled in the art may be made in the arrangement, operation and details of the method and apparatus of the present invention disclosed herein, without departing from the spirit and scope of the invention as defined in the following claims.

What is claimed is:

1. A method for modifying a behavior of an input device when the input device is lifted from a surface, the method comprising:
illuminating a pattern on the surface using a light source;
receiving at a sensor, a pattern formed by light received from the illuminated pattern on the surface;
detecting a position of the pattern received on the sensor;
computing the distance between the position and a reference position of the pattern on the sensor; and
in response to the distance being greater than a threshold, modifying the behavior of the input device,
wherein the computed distance is independent of characteristics of the surface.

2. The method of claim 1, wherein the reference position stored in a memory in the input device.

3. The method of claim 1, wherein reference position is a memorized minimum value.

4. The method of claim 1, wherein the step of modifying the behavior of the input device comprises:
optimizing the movement of a cursor associated with the movement of the input device relative to the surface in a plane parallel to the surface.

5. The method of claim 1, wherein the threshold can be manipulated by a user of the input device.

6. The method of claim 1, further comprising:
providing a measure of the height of lift from the surface based upon the distance between the first position and the second position.

7. The method of claim 1, further comprising:
allowing the user to specify the threshold.

8. The method of claim 1, further comprising:
illuminating a second pattern on the surface using a second light source; and
receiving at the sensor, a second pattern formed by light from the second illuminated pattern on the surface.

9. An optical input device comprising:
an optical displacement detection module for providing information regarding X-Y displacement of the optical device relative to a surface; and
an optical lift detection module for providing information regarding the height of the optical input device relative to the surface,
wherein the information provided by the lift detection module is used to optimize at least one of the output of the optical displacement detection module and a power consumption of the optical input device.

10. The optical input device of claim 9, wherein the optical lift detection module comprises:
a light source optimized for purposes of measuring the height of the optical input device relative to the surface;
an illumination lens for directing light from the light source on to the surface at an angle;
a sensor optimized for purposes of measuring the height of the optical input device relative to the surface; and
an imaging lens for directing light from the surface on to the sensor at a specular angle.

11. The optical input device of claim 10, wherein the sensor comprises a linear array of photo-sensors.

12. The optical input device of claim 10, wherein the light source is an infra-red LED.

13. The optical input device of claim 10, further comprising:
a continuous bottom case.

14. A method for detecting lift of an input device off a surface, the input device having a housing, the method comprising:
embedding at least two electrodes of a capacitor in a bottom portion of the h housing;
measuring a first value of the capacitor when the input device is resting on the surface;
measuring a change in the value of the capacitor;
in response to the change in the value of the capacitor being greater than a threshold, providing an indication of an amount by which the input device is lifted off the surface.

15. The method of claim 14, where a compressable material is inserted between the two electrodes of the capacitor.

16. An input device for controlling a movement of a cursor on an associated display in response to movement of the input device relative to a surface, the input device comprising:
a housing having a top and a bottom portion;
an elastic membrane coupled to the bottom portion;
a spacer supporting the elastic membrane, so that the elastic membrane is pushed into the input device when the input device is resting on the surface; and
a height-detection module which is coupled to the elastic membrane.

17. The input device of claim 16, wherein the height detection module comprises:
a light source;
a sensor for receiving light emitted by the light source;
an obturator for modulating the light from the light source from reaching the sensor.

18. The input device of claim 17, wherein the obturator has a progressive effect when the mouse is lifted from the table.

19. The input device of claim 16, wherein the height detection module comprises a mechanical plunger.

20. The input device of claim 19, further comprising
a switch coupled to the mechanical plunger, wherein the switch is manipulable by a user.

21. A method for modifying the behavior of an input device based upon a height to which the input device is lifted off a surface, the method comprising:
computing the height of the input device from a surface;
comparing the height to a threshold value;
comparing the height to a second threshold value; and
in response to the height being greater than the second threshold value, modifying the behavior of the input device.

22. The method of claim 21, wherein the step of modifying the behavior of the input device comprises:
entering an in-air mode.

23. The method of claim 21, wherein the step of modifying the behavior of the input device comprises:
using a gesture of the input device to control an application-specific function, wherein the application-specific function is at least one of panning and zooming.

24. The method of claim 21, further comprising:
in response to the height being greater than the first threshold value and smaller than the second threshold value, registering that the input device is lifted.

25. An optical input device comprising:
a first light source for creating a first pattern on a surface;
a second light source for creating a second pattern on the surface; and
a sensor for receiving light from the first pattern and the second pattern,
wherein the first pattern is used to obtain information regarding X-Y displacement of the optical device relative to the surface and the second pattern is used to obtain information regarding a height of the optical input device relative to the surface.

26. An input device for measuring X-Y displacement relative to a surface and for measuring height of the input device relative to the surface, comprising:
an X-Y displacement detection for providing information regarding X-Y displacement of the input device relative to the surface; and
a height detection module for providing information regarding the height of the input device relative to the surface,
wherein the information regarding the height of the input device is used to trigger an event provided the height of the input device is within a specified range.

27. The input device of claim 26, wherein the trigger event is assigned to an application control.

28. The input device of claim 26, wherein the range is changeable by a user of the input device.

29. The input device of claim 26, wherein a user can set a second threshold to trigger a second event.

30. The input device of claim 29, wherein the second event is one of a group consisting of implementing gesture control, triggering a media function, allowing drawing using the input device, panning, tilting, zooming, and switching from 2D to 3D functionality.
